(19) United States
(12) Patent Application Publication
(10) Pub. No.: US 2019/0011766 A1
(43) Pub. Date: Jan. 10, 2019

(54) COLOR FILTER SUBSTRATE AND MANUFACTURING METHOD THEREOF

(71) Applicant: Shenzhen China Star Optoelectronics Semiconductor Display Technology Co., Ltd., Shenzhen, Guangdong (CN)

(72) Inventor: Zhuming DENG, Shenzhen, Guangdong (CN)

(73) Assignee: Shenzhen China Star Optoelectronics Semiconductor Display Technology Co., Ltd., Shenzhen, Guangdong (CN)

(21) Appl. No.: 15/576,975

(22) PCT Filed: Jun. 26, 2017
(86) PCT No.: PCT/CN2017/089936

§ 371 Date: Nov. 27, 2017

(30) Foreign Application Priority Data
May 16, 2017 (CN) 201710344095.2

(51) Int. Cl. G02F 1/1335; G02F 1/1339

(52) U.S. Cl. CPC G02F 1/133516; G02F 1/13394; G02F 1/133512

(57) ABSTRACT

A color filter substrate and its manufacturing method are disclosed. The method includes the following steps: providing a substrate; forming a lower layer on the substrate, and patterning the lower layer to form at least an indentation; forming a black matrix layer on the lower layer and the indentation, and patterning the black matrix layer to form a black matrix pattern, and at least a first spacer and at least a second spacer integrally on the black matrix pattern. The first spacer is outside the indentation. The second spacer is inside the indentation. There is a vertical distance between a top side of the first spacer and a top side of the second spacer. Through the above method, the photolithographic process is simplified and production cost is reduced.

### BACKGROUND OF THE INVENTION

### 1. Field of the Invention

The present disclosure generally relates to liquid crystal display panels, and particularly relates to a color filter substrate and its manufacturing method.

### 2. The Related Arts

A liquid crystal display (LCD) usually includes a pair of substrates spaced apart in parallel. The space between the substrates is referred to as liquid crystal cell gap or cell gap, and is filled with liquid crystal molecules and spacers.

The spacers maintain a uniform thickness for the LCD, thereby preventing blurred display images from uneven thickness.

Conventional spacers are spherical, and are not fixed to the substrates. If pressure is applied to the LCD and spherical spacers are displaced, liquid crystal molecules would flow around, causing uneven thickness and phenomena such as un-uniform brightness and color shift.

The conventional spherical spacers are arranged through coating, and it is difficult to effectively control their distribution density. If the size and distribution of the spacers are not uniform, the flatness of the LCD and the overall display quality would be affected. There are also column-shaped spacers which provide superior uniformity and shock absorption and therefore begin to replace the spherical spacers.

Existing LCDs often adopt two types of spacers of different heights. The higher ones maintain the evenness of the liquid crystal molecules within the cell gap. The lower ones provide buffer effect when the LCD undergoes some pressure (such as manual depression), reducing the adversary influence to display quality.

Photolithography is an important step in providing the spacers. Spacers are formed by exposing and curing photoresist. Photo mask of different transmittances is used to control exposure depth and therefore the height of the spacers.

To form the black matrix pattern and spacers of two heights in a single step therefore would require a photo mask of three transmittances. This is a more difficult process and the cost of the photo mask is also more expensive.

### SUMMARY OF THE INVENTION

A major objective of the present disclosure is to provide a color filter substrate and its manufacturing method that may simplify the photolithographic process and reduce production cost.

To achieve the objective, the present disclosure teaches a manufacturing method including the following steps.

A substrate is provided, a lower layer is formed on the substrate, and the lower layer is patterned to form at least an indentation.

Then a black matrix layer is formed on the lower layer and the indentation, and the black matrix layer is patterned to form a black matrix pattern, and at least a first spacer and at least a second spacer integrally on the black matrix pattern. The first spacer is outside the indentation. The second spacer is inside the indentation. There is a vertical distance between a top side of the first spacer and a top side of the second spacer.

To achieve the objective, the present disclosure teaches a color filter substrate.

The color filter substrate includes a substrate, a lower layer having at least an indentation on the substrate, a black matrix pattern on the lower layer, and at least a first spacer and at least a second spacer integrally formed on the black matrix pattern. The first spacer is outside the indentation. The second spacer is inside the indentation. There is a vertical distance between a top side of the first spacer and a top side of the second spacer.

The advantages of the present disclosure are as follows. By patterning the lower layer, the formation of the black matrix pattern and the spacers having vertical distance in between is combined in a single step. Compared to the prior art which requires a photo mask of three transmittances, the present disclosure reduces the requirement for photo mask, simplifies the photolithographic process, and lowers production cost.

### BRIEF DESCRIPTION OF THE DRAWINGS

To make the technical solution of the embodiments according to the present disclosure, a brief description of the drawings that are necessary for the illustration of the embodiments will be given as follows. Apparently, the drawings described below show only example embodiments of the present disclosure and for those having ordinary skills in the art, other drawings may be easily obtained from these drawings without paying any creative effort. In the drawings:

FIG. 1 is a flow diagram showing the steps of a manufacturing method for a color filter substrate according to an embodiment of the present disclosure;

FIG. 2 is a schematic diagram showing the color filter substrate after the steps of FIG. 1;

FIG. 3 is a schematic diagram showing a color filter substrate produced from the method of FIG. 1;

FIG. 4 is a flow diagram showing the steps of a manufacturing method for a color filter substrate according to another embodiment of the present disclosure;

FIG. 5 is a schematic diagram showing the color filter substrate after the steps of FIG. 4; and

FIG. 6 is a schematic diagram showing a color filter substrate produced from the method of FIG. 4.

### DETAILED DESCRIPTION OF THE PREFERRED EMBODIMENTS

In the following, the present disclosure is explained in details through embodiments and accompanying drawings. It should be understood that not all possible embodiments are disclosed. Other embodiments derived from the following embodiments by a reasonably skilled person in the art without significant inventive effort should be considered to be within the scope of the present disclosure.

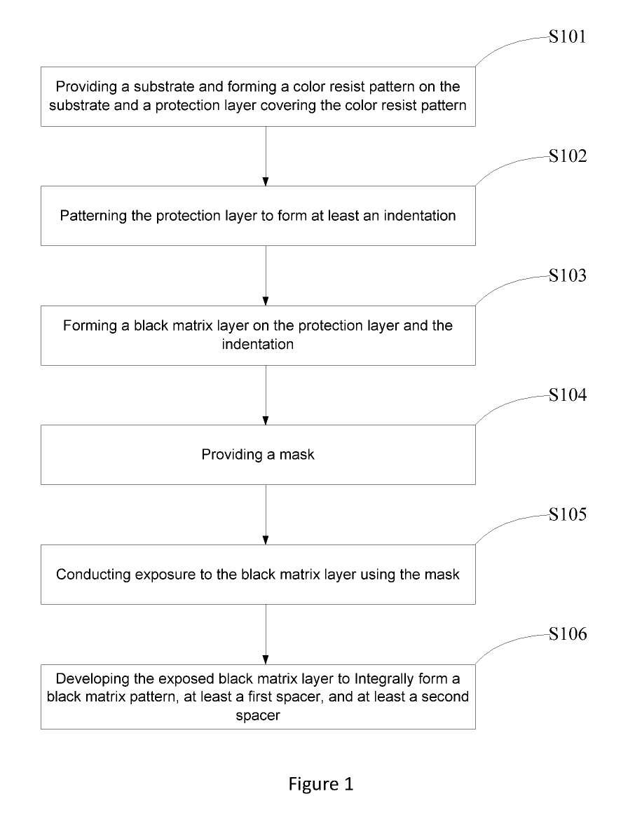

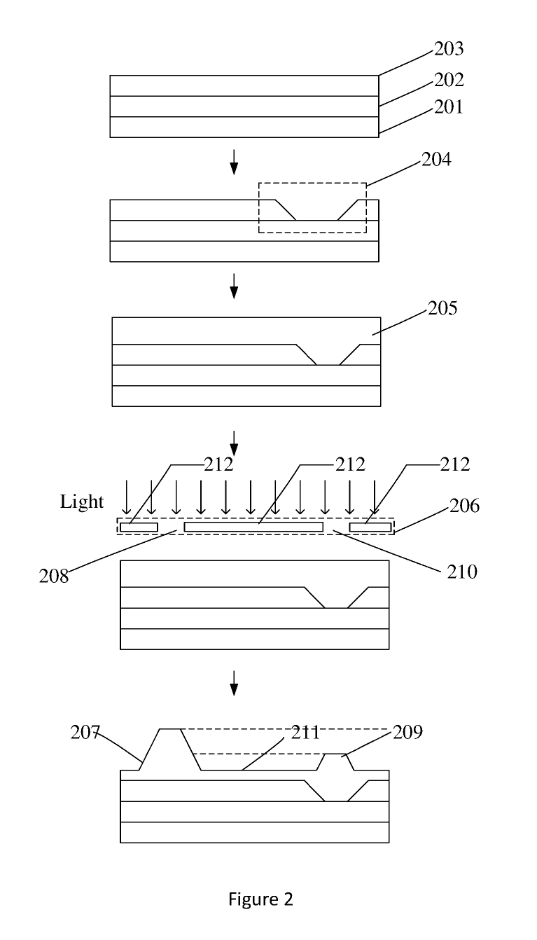

FIG. 1 is a flow diagram showing the steps of a manufacturing method for a color filter substrate according to an embodiment of the present disclosure. FIG. 2 is a schematic diagram showing the color filter substrate after the steps of FIG. 1.

In step S101, a substrate 201 is provided. A color resist layer 202 and a protection layer 203 covering the color resist layer 202 are sequentially formed on the substrate 201.

In step S102, the protection layer 203 is patterned to form at least an indentation 204.

Conventional lithography or similar art may be applied to form the indentation 204, which may be polygonal, circular, or elliptic in shape.

In step S103, a black matrix layer 205 is formed on the protection layer 203 and the indentation 204.

The black matrix layer 205 is formed by coating negative photoresist material which, after exposure to light, becomes insoluble by photo curing reaction.

In step S104, a mask 206 is provided.

The mask 206 includes a first mask area 208 corresponding to at least a first spacer 207, a second mask area 210 corresponding to at least a second spacer 209, a remaining third mask area 212 corresponding to a black matrix pattern 211 outside the first and second mask areas 208 and 210. The first and second mask areas 208 and 210 have 100% transmittance. The third mask area 212 has 20% transmittance.

As persons of the related art may understand, the black matrix layer 205 may also be made of positive photoresist material. Then, the mask 206 has to be configured accordingly. All is required that the first mask area 208 corresponding to the first spacer 207 and the second mask area 210 corresponding to the second spacer 209 are of a same transmittance, and the third mask area 212 corresponding to the black matrix pattern 211 outside the first and second mask areas 208 and 210 is of a different transmittance.

In step S105, exposure of the black matrix layer 205 is conducted using the mask 206.

Light is shined on a top side of the black matrix layer 205 corresponding to the mask 206. Alternatively, the light may be ultraviolet light.

In step S106, the exposed black matrix layer 205 is developed and the back matrix pattern 211, the first spacer 207, and the second spacer 209 are integrally formed.

The first spacer 207 is outside the indentation 204, the second spacer 209 is in the indentation 204, and there is a vertical distance between first and second spacers 207 and 209's top sides.

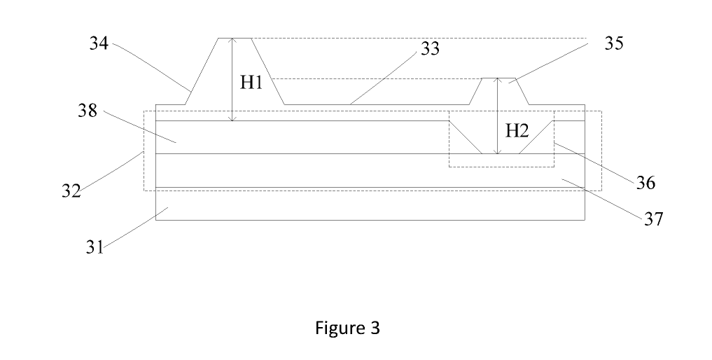

FIG. 3 is a schematic diagram showing a color filter substrate produced from the method of FIG. 1. As illustrated, the color filter substrate includes a substrate 31, a lower layer 32 on the substrate 31, a black matrix pattern 33 on the lower layer 32, at least a first spacer 34 and at least a second spacer 35 integrally formed on the black matrix pattern 33. At least an indentation 36 is formed on the lower layer 32. The first spacer 34 is outside the indentation 36. The second spacer 35 is inside the indentation 36. There is a vertical distance between a top side of the first spacer 34 and a top side of the second spacer 35.

The lower layer 32 includes a color resist pattern 37 and a protection layer 38 covering the color resist pattern 37. The indentation 36 is formed on the protection layer 38 using conventional lithography or similar art.

A height H1 spanning the first spacer 24 and the black matrix pattern 33 beneath the first spacer 24 is equal to a height H2 spanning the second spacer 35 and the black matrix pattern 33 beneath the second spacer 35.

As described above, the present embodiment has achieved the formation of the black matrix pattern and the spacers having vertical distance in between in a single step, reducing the requirement for photo mask, simplifying the photolithographic process, and lowering production cost.

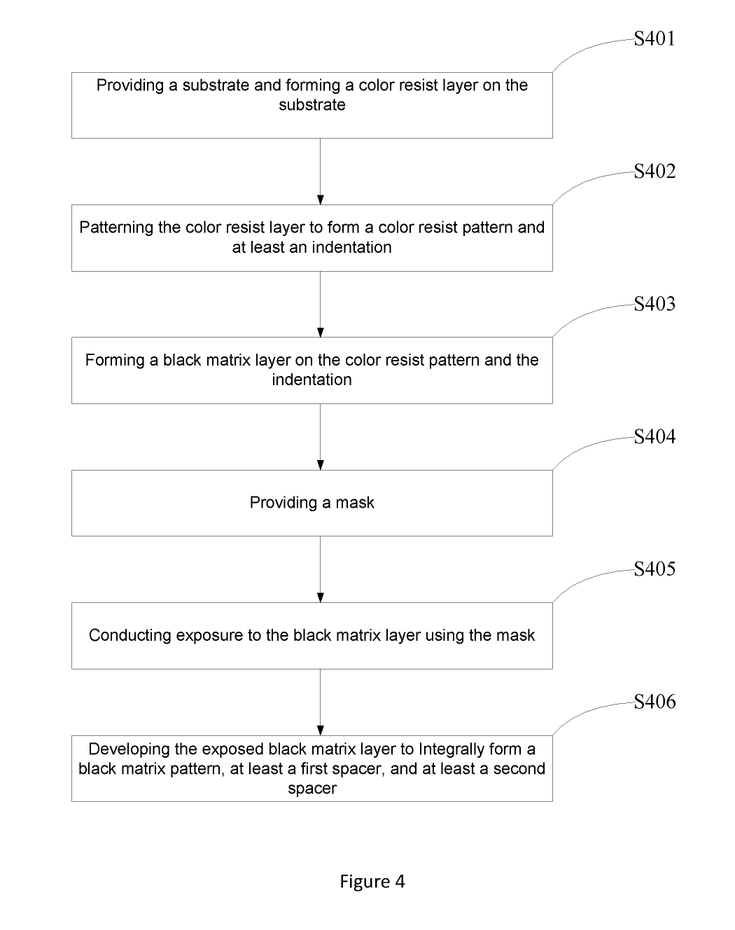

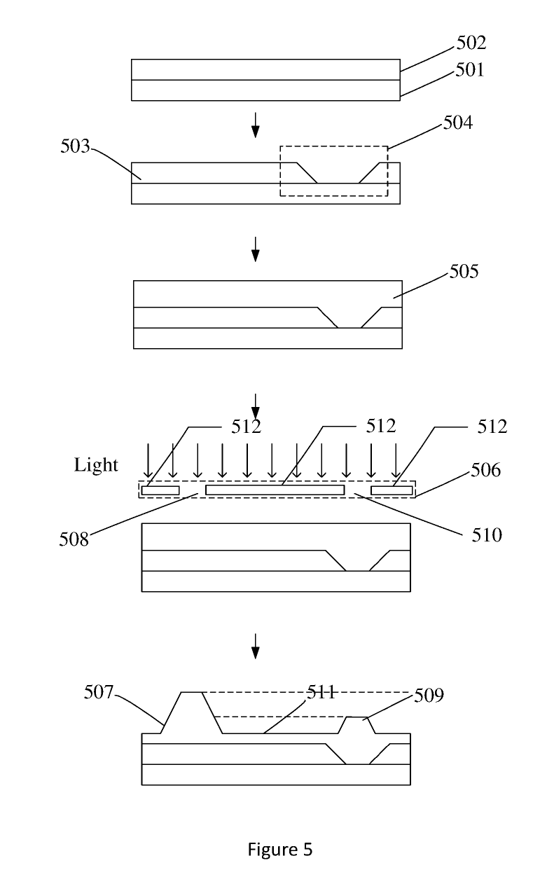

FIG. 4 is a flow diagram showing the steps of a manufacturing method for a color filter substrate according to another embodiment of the present disclosure. FIG. 5 is a schematic diagram showing the color filter substrate after the steps of FIG. 4.

In step S401, a substrate 501 is provided. A color resist layer 502 is formed on the substrate 501.

In step S402, the color resist layer 502 is patterned to form a color resist pattern 503 and at least an indentation 504 on the color resist pattern 503.

Conventional lithography or similar art may be applied to form the indentation 504, which may be polygonal, circular, or elliptic in shape.

In step S403, a black matrix layer 505 is formed on the color resist pattern 503 and the indentation 504.

The black matrix layer 505 is formed by coating negative photoresist material which, after exposure to light, becomes insoluble by photo curing reaction.

In step S404, a mask 506 is provided.

The mask 506 includes a first mask area 508 corresponding to at least a first spacer 507, a second mask area 510 corresponding to at least a second spacer 509, a remaining third mask area 512 corresponding to a black matrix pattern 511 outside the first and second mask areas 508 and 510. The first and second mask areas 508 and 510 have 100% transmittance. The third mask area 512 has 20% transmittance.

As persons of the related art may understand, the black matrix layer 505 may also be made of positive photoresist material. Then, the mask 506 has to be configured accordingly. All is required that the first mask area 508 corresponding to the first spacer 507 and the second mask area 510 corresponding to the second spacer 509 are of a same transmittance, and the third mask area 512 corresponding to the black matrix pattern 511 outside the first and second mask areas 508 and 510 is of a different transmittance.

In step S405, exposure of the black matrix layer 505 is conducted using the mask 206.

Light is shined on a top side of the black matrix layer 505 corresponding to the mask 206. Alternatively, the light may be ultraviolet light.

In step S406, the exposed black matrix layer 505 is developed and the back matrix pattern 511, the first spacer 507, and the second spacer 509 are integrally formed.

The first spacer 507 is outside the indentation 504, the second spacer 509 is in the indentation 504, and there is a vertical distance between first and second spacers 507 and 509's top sides.

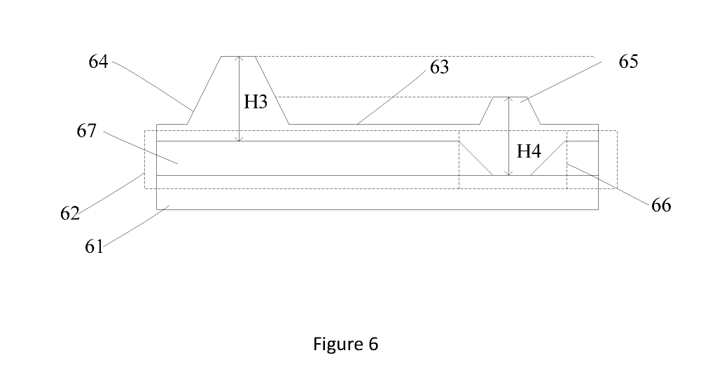

FIG. 6 is a schematic diagram showing a color filter substrate produced from the method of FIG. 4. As illustrated, the color filter substrate includes a substrate 61, a lower layer 62 on the substrate 61, a black matrix pattern 63 on the lower layer 62, at least a first spacer 64 and at least a second spacer 65 integrally formed on the black matrix pattern 63. At least an indentation 66 is formed on the lower layer 62. The first spacer 64 is outside the indentation 66. The second spacer 65 is inside the indentation 66. There is a vertical distance between a top side of the first spacer 64 and a top side of the second spacer 65.

The lower layer 62 includes a color resist pattern 67. The indentation 66 is formed on the color resist pattern 67 using conventional lithography or similar art.

A height H3 spanning the first spacer 64 and the black matrix pattern 63 beneath the first spacer 64 is equal to a height H4 spanning the second spacer 65 and the black matrix pattern 63 beneath the second spacer 65.

As described above, the present embodiment has achieved the formation of the black matrix pattern and the spacers having vertical distance in between in a single step, reducing the requirement for photo mask, simplifying the photolithographic process, and lowering production cost.

In the above embodiments, the protection layer and the color resist layer are exemplary. For persons of the related art, it is understandable that the indentation may be formed on an arbitrary layer beneath the black matrix layer, and the objective of the present disclosure may still be achieved.

Embodiments of the present disclosure have been described, but not intending to impose any unduly constraint to the appended claims. Any modification of equivalent structure or equivalent process made according to the disclosure and drawings of the present disclosure, or any application thereof, directly or indirectly, to other related fields of technique, is considered encompassed in the scope of protection defined by the claims of the present disclosure.

What is claimed is:

1. A method for manufacturing a color filter substrate, comprising
providing a substrate;
forming a lower layer on the substrate, and patterning the lower layer to form at least an indentation; and
forming a black matrix layer on the lower layer and the indentation, and patterning the black matrix layer to form a black matrix pattern, and at least a first spacer and at least a second spacer integrally on the black matrix pattern;
wherein the first spacer is outside the indentation; the second spacer is inside the indentation; there is a vertical distance between a top side of the first spacer and a top side of the second spacer; and a first height spanning the first spacer and the black matrix pattern beneath the first spacer is equal to a second height spanning the second spacer and the black matrix pattern beneath the second spacer.

2. The method as claimed in claim 1, wherein the step of forming and patterning the lower layer comprises the steps of:
forming a color resist layer and a protection layer covering the color resist layer sequentially on the substrate; and
patterning the protection layer to form the indentation on the protection layer.

3. The method as claimed in claim 1, wherein the step of forming and patterning the lower layer comprises the steps of:
forming a color resist layer on the substrate; and
patterning the color resist layer to form a color resist pattern and the indentation on the color resist pattern.

4. The method as claimed in claim 1, wherein the step of forming and patterning the black matrix layer comprises the steps of:
providing a mask;
conducting exposure to the black matrix layer using the mask; and
developing the exposed black matrix layer to form the back matrix pattern, the first spacer, and the second spacer;
wherein the mask comprises a first mask area corresponding to the first spacer, a second mask area corresponding to the second spacer, a third mask area corresponding to a black matrix pattern outside the first and second mask areas; and the first and second mask areas have a first transmittance different from a second transmittance of the third mask area.

5. The method as claimed in claim 4, wherein the black matrix layer is made of negative photoresist material; and the first transmittance is higher than the second transmittance.

6. The method as claimed in claim 5, wherein the first transmittance is 100%.

7. A method for manufacturing a color filter substrate, comprising
providing a substrate;
forming a lower layer on the substrate, and patterning the lower layer to form at least an indentation; and
forming a black matrix layer on the lower layer and the indentation, and patterning the black matrix layer to form a black matrix pattern, and at least a first spacer and at least a second spacer integrally on the black matrix pattern;
wherein the first spacer is outside the indentation; the second spacer is inside the indentation; and there is a vertical distance between a top side of the first spacer and a top side of the second spacer.

8. The method as claimed in claim 7, wherein the step of forming and patterning the lower layer comprises the steps of:
forming a color resist layer and a protection layer covering the color resist layer sequentially on the substrate; and
patterning the protection layer to form the indentation on the protection layer.

9. The method as claimed in claim 7, wherein the step of forming and patterning the lower layer comprises the steps of:
forming a color resist layer on the substrate; and
patterning the color resist layer to form a color resist pattern and the indentation on the color resist pattern.

10. The method as claimed in claim 7, wherein the step of forming and patterning the black matrix layer comprises the steps of:
providing a mask;
conducting exposure to the black matrix layer using the mask; and
developing the exposed black matrix layer to form the back matrix pattern, the first spacer, and the second spacer;
wherein the mask comprises a first mask area corresponding to the first spacer, a second mask area corresponding to the second spacer, a third mask area corresponding to a black matrix pattern outside the first and second mask areas; and the first and second mask areas have a first transmittance different from a second transmittance of the third mask area.

11. The method as claimed in claim 10, wherein the black matrix layer is made of negative photoresist material; and the first transmittance is higher than the second transmittance.

12. The method as claimed in claim 11, wherein the first transmittance is 100%.

13. A color filter substrate, comprising
a substrate;
a lower layer having at least an indentation on the substrate;
a black matrix pattern on the lower layer; and
at least a first spacer and at least a second spacer integrally formed on the black matrix pattern;
wherein the first spacer is outside the indentation; the second spacer is inside the indentation; and there is a vertical distance between a top side of the first spacer and a top side of the second spacer.

14. The method as claimed in claim 13, wherein the lower layer comprises a color resist pattern on the substrate and a protection layer covering the color resist pattern; and the indentation is on the protection layer.

15. The method as claimed in claim 13, wherein the lower layer comprises a color resist pattern on the substrate; and the indentation is on the color resist pattern.

16. The method as claimed in claim 13, wherein a first height spanning the first spacer and the black matrix pattern beneath the first spacer is equal to a second height spanning the second spacer and the black matrix pattern beneath the second spacer.
